(19) United States
(12) Patent Application Publication
(10) Pub. No.: US 2009/0127342 A1
(43) Pub. Date: May 21, 2009

(54) Imaging Bar Code Reader with Illumination Control System

(75) Inventors: James R. Giebel, Centerport, NY (US); William Sackett, Rocky Point, NY (US); Bradley S. Carlson, Huntington, NY (US)

Correspondence Address: Tarolli, Sundheim, Covell & Tummino L.L.P, 1300 East Ninth Street, Suite 1700, Cleveland, OH, 44114, US

(73) Assignee: Symbol Technologies, Inc., Holtsville, NY (US)

(21) Appl. No.: 11/943,001

(22) Filed: Nov. 20, 2007

(51) Int. Cl. G06K 7/10

(52) U.S. Cl. 235/462.42; 235/462.01; 235/462.06; 235/462.15

(57) ABSTRACT

The disclosed bar code reader includes an auto-focusing component for rapidly producing in focus images. An imaging system makes use of an aiming pattern that impinges upon the coded indicia of a target. The imaging system includes a light monitoring pixel array and a focusing lens that is fixed with respect to the pixel array for transmitting an image of the target object onto the pixel array. The bar code reader also includes an illumination system comprising one or more light emitting diodes for illuminating a the target within a field of view defined by the optical system. A drive circuit coupled to the light emitting diodes of the illumination system including at least one energy storage capacitor for providing an electrical pulse that illuminates the target. A controller selectively energizes the light emitting diodes by discharging the at least one capacitor of the drive circuit.

### FIELD OF THE INVENTION

The present invention relates to an imaging-based bar code reader having a high intensity target illumination system.

### BACKGROUND OF THE INVENTION

Various electro-optical systems have been developed for reading optical indicia, such as bar codes. A bar code is a coded pattern of graphical indicia comprised of a matrix or series of bars and spaces of varying widths, the bars and spaces having differing light reflecting characteristics. Systems that read and decode bar codes employing CCD or CMOS-based imaging systems are typically referred to as imaging-based bar code readers or bar code scanners.

Imaging systems include CCD arrays, CMOS arrays, or other imaging pixel arrays having a plurality of photosensitive elements or pixels. Light reflected from a target image, e.g., a target bar code is focused through a lens of the imaging system onto the pixel array. Output signals from the pixels of the pixel array are digitized by an analog-to-digital converter. Decoding circuitry of the imaging system processes the digitized signals and attempts to decode the imaged bar code.

The ability of an imaging system to successfully decode an imaged bar code is dependent upon the ability to satisfactorily capture a clear image of the target bar code that is focused onto the pixel array.

### SUMMARY

An exemplary system is used with an imaging based barcode reader for imaging a target and has an imaging system that includes a light monitoring pixel array and an optical system having one or more focusing lenses positioned with respect to the pixel array to transmit an image of a target object toward the pixel array.

The exemplary bar code reader also includes an illumination system having one or more light emitting diodes for illuminating a target within a field of view defined by the optical system. A drive circuit coupled to the light emitting diodes of the illumination system has at least one energy storage capacitor for providing an electrical pulse that illuminates the target. A controller selectively energizes the light emitting diodes by discharging the capacitor of the drive circuit through the light emitting diodes.

The controller is notified that the illumination system is ready to deliver a short burst of current to the one or more light emitting diodes, and in the illustrated system, this is done by monitoring when a threshold voltage on the capacitor is exceeded as the capacitor is being charged. The illumination system also notifies the controller when the capacitor has been fully discharged, and provides the controller other information such that the controller, at anytime, can estimate the amount of energy that is stored in the capacitor.

These and other objects advantages and features of the invention will become further understood from reference to the accompanying description of an exemplary embodiment of the invention when considered in conjunction with the accompanying drawings.

### BRIEF DESCRIPTION OF THE DRAWINGS

FIG. 1 is a schematic block diagram of an imaging-based bar code reader of the present invention having an automatic focusing system;

FIG. 2 is a depiction of a housing for supporting the components depicted in FIG. 1;

FIG. 3 is a schematic depiction of a control circuit for providing a high intensity flash from a light emitting diode illumination source;

FIG. 4 is a schematic of a programmable current source;

FIG. 5 and FIG. 6 are current vs time depictions of two bar code reader illumination modes;

FIG. 7 is a block diagram showing a voltage sense portion of the FIG. 3 depiction; and

FIG. 8 is depiction of voltage across a charging capacitor as a function of time.

### DETAILED DESCRIPTION

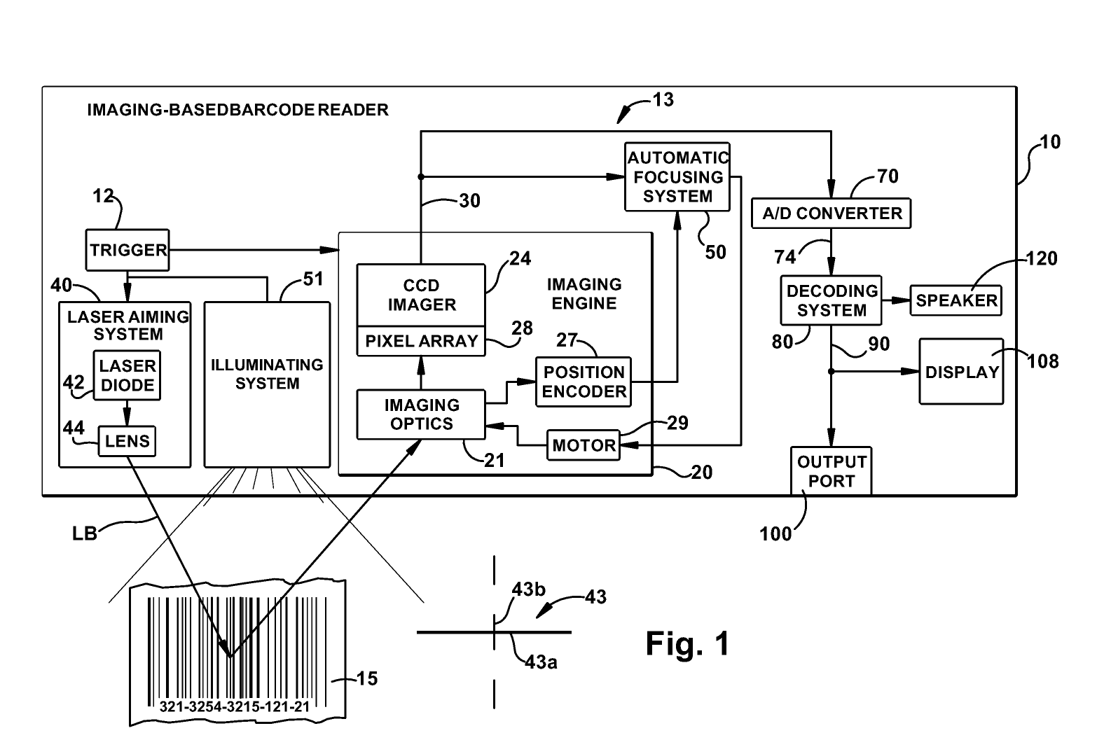

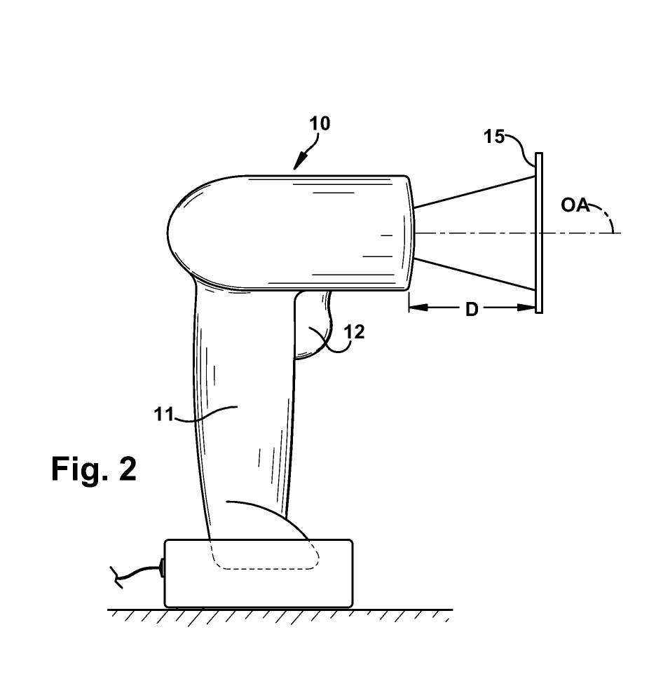

A block diagram of an imaging-based bar code reader 10 is shown schematically in FIG. 1. The bar code reader 10, in addition to imaging and decoding both 1D and 2D bar codes and postal codes, is also capable of capturing images and signatures. In one preferred embodiment of the present invention, the bar code reader 10 is a hand held portable reader components of which are supported within a housing 11 (FIG. 2) that can be carried and used by a user walking or riding through a store, warehouse or plant for reading bar codes for stocking and inventory control purposes.

A bar code reader of the present invention, however, may be advantageously used in connection with any type of imaging-based automatic identification system including, but not limited to, bar code readers, signature imaging acquisition and identification systems, optical character recognition systems, fingerprint identification systems and the like. It is the intent of the present invention to encompass all such imaging-based automatic identification systems.

The bar code reader 10 includes a trigger 12 coupled to bar code reader circuitry 13 for initiating reading of a target bar code 15 positioned on an object when the trigger 12 is pulled or pressed. The bar code reader 10 includes an imaging component 20 including imaging optics 21 and a CCD imager 24.

One or more lenses focus light reflected from the target bar code 15 onto an array of photosensors or pixels 28 of the CCD imager 24. In one embodiment, the reader 10 includes an auto focus system 50 that moves at least one lens with a motor 29 having an output transmission coupled to the lens and whose movement is monitored with a position encoder 27. The pixels of the pixel array 28 are read out generating an analog signal at an output 30 representative of an image of whatever is focused by the imaging optics 21 onto the pixel array 28, for example, an image of the bar code 15 intersected by the reader's optical axis OA. The analog image signal at the output 30 is then digitized by an analog-to-digital converter 70 and a digitized signal at an output 74 is decoded by decoder circuitry 80. Decoded data 90, representative of the data/information coded in the bar code 15 is then output via a data output port 100 and/or displayed to a user of the reader 10 via a display 108. Upon achieving a good “read” of the bar code 15, that is, the bar code 15 was successfully imaged and decoded, a speaker 120 is activated by the circuitry 13 to indicate to the user that the bar code has been successfully read.

The reader 10 further includes an aiming pattern generator 40 that generates a visible aiming pattern 43 to aid the user in properly aiming the reader at the target bar code 15. In one preferred embodiment, the aiming generator 40 is a laser aiming apparatus. Alternatively, the aiming apparatus 40 may utilize an LED or another source of illumination known to those of skill in the art. The pattern 43 may be a pattern comprising a crosshair formed from a thick horizontal line 43a and a perpendicular thin vertical line 43b. In one preferred embodiment, the laser aiming apparatus 40 includes a laser diode 42 and a diffractive lens 44.

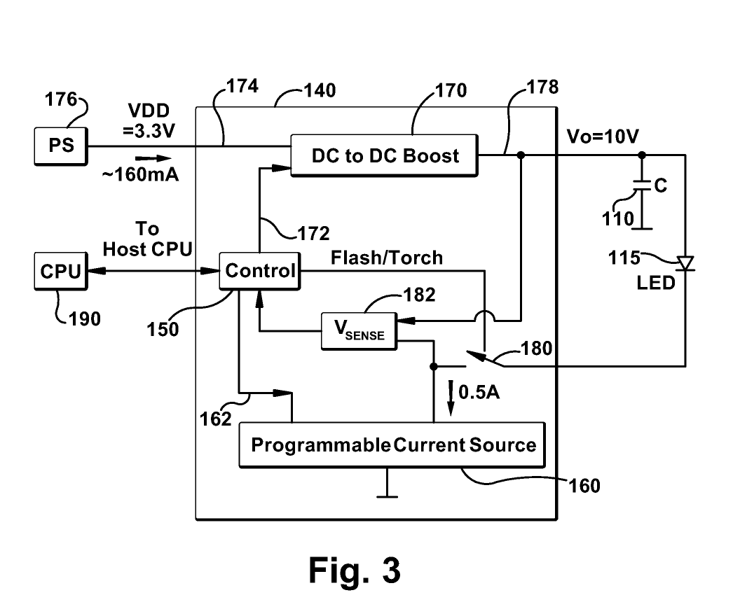

In the illustrated embodiment, in addition to the aiming pattern generator 40, the reader 10 includes a separate illumination system 51 for shining illumination light onto the target bar code 15. The illumination system includes a capacitor 110 (FIG. 3) that is coupled to a light emitting diode 115 that directs light onto the target bar code.

The CCD or CMOS sensors that make up the imager 24 sense light reflected back from the target surface and form pixel data corresponding to an image of the target. It is advantageous to use an array sensor that has the capability to output a portion of pixels upon request, so that the transfer time and processing time can be shortened when only a portion of the array is properly exposed. One such sensor is a CMOS array made by Micron having part number MT9M001. The pixel data from the array is converted into digital data by an A/D converter 70 that is decoded by decoding system 80. An output port or display 108 provides the results of decoding to a peripheral device (not shown) or displays them to the user. The scanner 10 also includes an illumination source (not shown) that is capable, within a prescribed scanner range, of illuminating a portion of the target surface sufficient to fill the entire two-dimensional array of sensors with data. The scanner includes an aiming pattern generator 40 that includes one or more laser diodes 42 and a focusing lens 44 (see FIG. 1) that is activated by a user actuated trigger 12.

### High Intensity Illumination Source

The exemplary illumination system 51 includes a light emitting diode 115 (FIG. 3) for illuminating the target 15 within a field of view at a focus distance D defined by the imaging optics 21. Although one LED is depicted in FIG. 3, this depiction symbolizes one or a multiple number of light emitting diodes connected in series to simultaneous illuminate the target. The focal distance D may either be fixed or variable depending on the construction of the imaging optics 21.

A drive circuit 140 (FIG. 3) coupled to the light emitting diode 115 charges an energy storage capacitor 110 that provides a current pulse through the diode 115. In a so called flash mode a short duration pulse causes the light emitting diode to emit a high intensity light pulse to illuminate the target. The drive circuit 140 has a control 150 for selectively energizing the light emitting diode by discharging the capacitor 110 in response to user actuation of the trigger 12. In the illustrated embodiment, the control 150 communicates with a controller 190 that performs other bar code reader functions such as decoding of an image. Alternately, the input from the trigger could be coupled directly to the control 150 to initiate a capacitor discharge. After discharging the capacitor, the system must re-charge the capacitor 110 before it can flash again—placing a limit on the duty cycle of flash mode operation.

The illumination system 140 has an programmable current source 160 for controlling a discharge rate or current from the capacitor through the LED 115 to a ground or a reference potential. In the illustrated embodiment the adjustable or programmable current control 160 is coupled to the control 150 for adjustment of the discharge current in response to a signal from the controller 190.

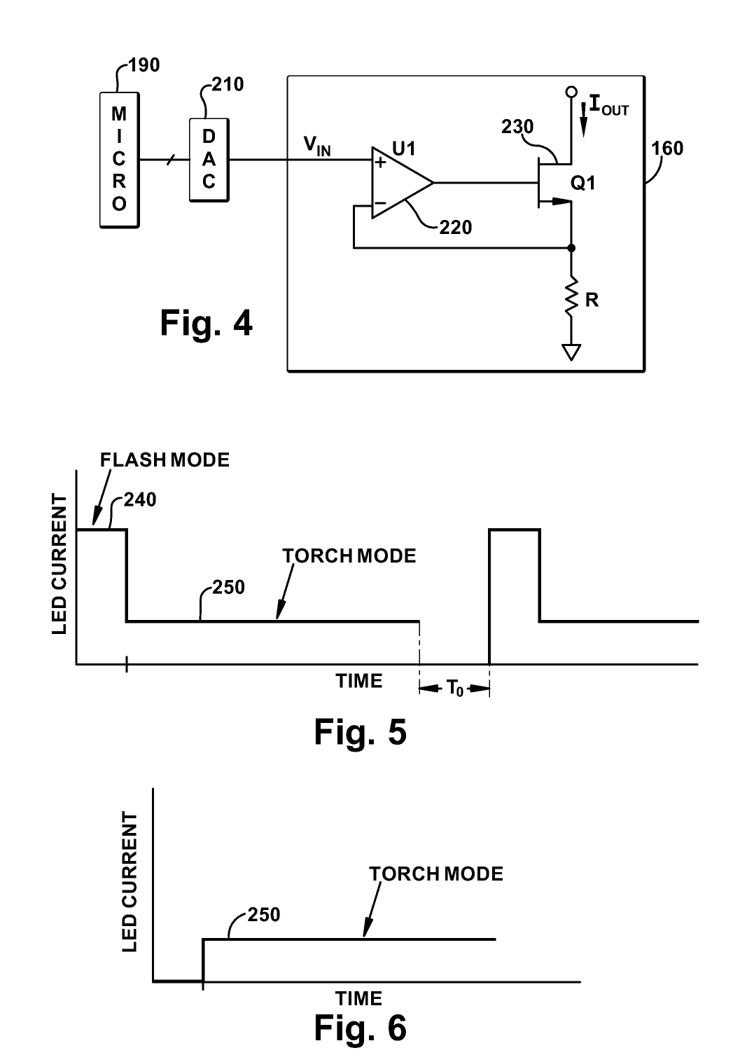

One suitable programmable current source 160 is disclosed in FIG. 4. The circuit is coupled to a digital to analog converter 210 that forms part of the control circuit 150 and receives control signals along a communications path from the host microprocessor or controller 190. The analog output from the digital to analog converter provides an analog input to an amplifier 220 having an output coupled to a gate input of a transistor 230. The transistor 230 is coupled to the LED 115 and as the capacitor 110 discharges through the LED its rate of discharge is controlled by the bias on the transistor 230 provided by the amplifier 220. The current Iₒᵤₜ is equal to Vᵢₙ/R so long as a minimum voltage (sometimes referred to as head room) of about 0.4V volts is maintained across the programmable current source.

The exemplary drive circuit 140 includes a DC to DC boost circuit 170 having a control input 172 coupled to the controller 150 and a voltage input 174 coupled to a bar code reader power supply 176 for providing energy to the capacitor. An output 178 from the boost circuit 170 provides a boosted voltage for charging the capacitor 110 in the range of 10-16 volts. One exemplary boost circuit 170 is implemented with a integrated circuit commercially available from Linear Technology Corporation of Milpitas, Calif. (www.linear.com) as part number LT 1618 designated as a constant-Current/Constant-Voltage 1.4 MHz Step-Up DC/DC Converter. The data sheet for part number LT1618 illustrates typical applications for this circuit and is incorporated herein by reference.

As described in the data sheet this circuit has a feedback pin (pin 1) that can be used to set the output voltage by selecting values for a resistor network (not shown). A second pin (pin 4) designated as I_{ADJ} is controlled with a DC voltage to control the output current of the voltage step up converter.

In the presently used embodiment, the input 172 from the control 150 is coupled to the LT1618 integrated circuit and contains signals that control the output voltage of the DC to DC converter as well as the peak input current that the DC to DC boost converter will pull from the host system power supply 176.

Discharge of the capacitor 110 is achieved by closing a switch 180 to provide a discharge path to ground through the programmable current source 160. The exemplary drive circuit 140 also has an option of maintaining a low level boost voltage across the light emitting diode. The low level (torch) output can be provided without first providing a flash. One typical LED activation uses an initial high intensity, flash of light output followed by a subsequent lower level constant LED output (torch) and is depicted by the plot of current versus time shown in FIG. 5. A high level discharge current 240 is followed by a low level current 250. This pattern can be repeated after a short re-charge time (T₀), see FIG. 5.

One embodiment of the controller 150 depicted in FIG. 7 has a dedicated microprocessor 220 that communicates with the host CPU 190. The boost circuit is programmed though outputs from digital to analog (DAC) converters 222, 224 to manage charge rate and peak current supplied by the power supply 176 (FIG. 3). In torch mode only, shown in FIG. 6, the boost circuit is controlled to maintain a specified current 250 at its output while switch 180 is held closed. This is accomplished by the control 150 adjusting the DC voltage at the input to pin 4 of the LT1618 circuit.

An option for the exemplary system is to include stacked LEDs in a series arrangement which are all simultaneously activated to produce light when the capacitor 110 is discharged.

The exemplary system can momentarily flash the LED(s) and then enter torch mode for a much longer period of time, or it can go directly into torch mode without using the flash mode. In one embodiment, the current that is supplied to the LED(s) in torch mode is programmable by controlling an input from the DAC 224 while the Vin (FIG. 4) is held high. This will cause the current source to saturate allowing the boost converter to dictate how much current is supplied to the LED(s) In flash mode, the discharge current and charging current are also programmable.

Alternatively, the programmable current source 160 of FIG. 4 could be biased to control LED current in torch mode. The output voltage of the DC to DC boost regulator would be regulated at a minimum voltage required to keep the programmable current source active (˜0.4V at the drain of the transistor Q1).

In the embodiment shown in FIG. 7, an analog to digital converter 230 provides a voltage input to the microprocessor 220. This feedback signal allows the control system, as an option, to adjust the output voltage (Vo) such that the voltage at the output 178 is held constant at a minimal voltage as a constant current is continuously delivered to the LED(s). This mode provides just enough voltage to bias the LED(s) thereby reducing the voltage at the current source to a minimum (torch mode)—this is a very efficient approach to avoid wasting power in the current source.

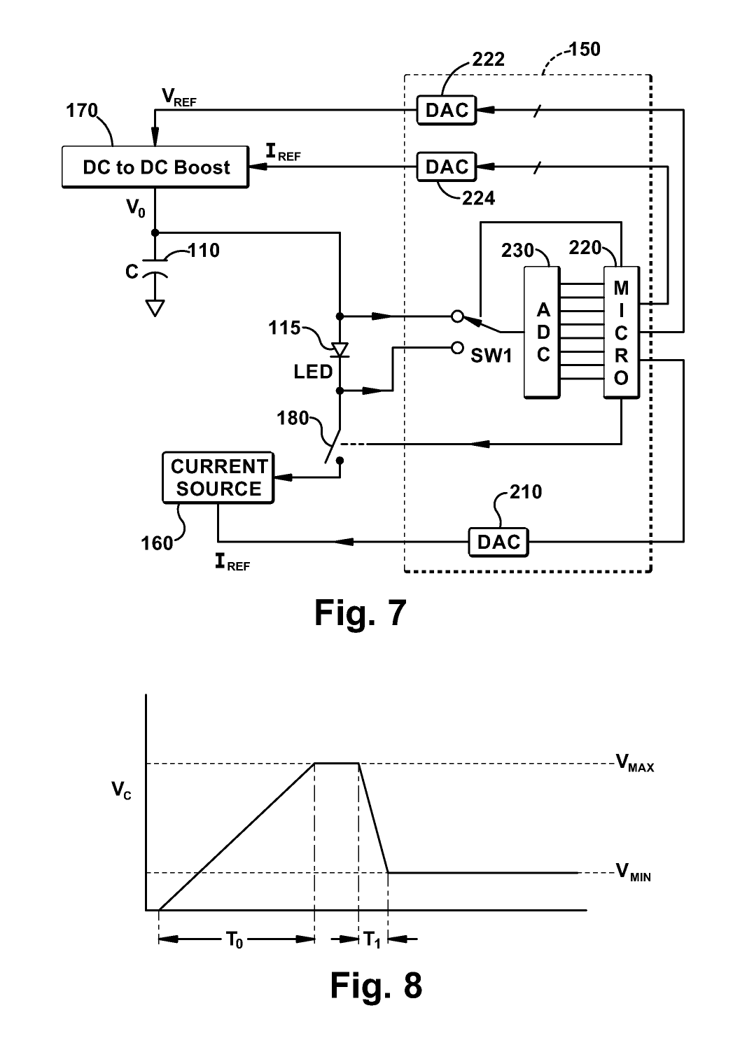

FIG. 8 is an illustration of voltage as a function of time on a representative capacitor during flash discharge of the capacitor followed by a sustaining torch mode. During a charging period T₀, the capacitor charges to its maximum voltage of Vₘₐₓ, which in the illustrated embodiment is between 10 and 16 volts. When the trigger is actuated, the capacitor discharges rapidly and the voltage on the capacitor reaches a minimum sustaining or torch voltage. In the FIG. 7 embodiment, the voltage on the capacitor is sensed by activating a switch SW1 to couple the input to the analog to digital converter 230 to the capacitor and determine when charging is completed and the capacitor is ready to be discharged in flash mode. Moving the switch SW1 to an alternate position allows the microprocessor to monitor a voltage at an LED cathode to determine when the capacitor has completely discharged and when the flash event has ended. Feeding these voltages back to the microprocessor allows the microprocessor to evaluate those values in software to determine how much charge is available on the capacitor. The microprocessor is then able to more aggressively charge and discharge to deliver more flash events in a given period, and to avoid unnecessary recharging delays. This is particularly useful when a full charge is not needed to expose a partial frame (to cover just the sweet spot of the target), and where it is determined that the capacitor has enough energy to deliver the required pulse for the job.

An ability to monitor and to respond to real time changes in capacitor voltage produces a more responsive, and aggressive bar code reader. This is true because the system does not need to be designed for the “worst case”, i.e., to accommodate component tolerances, or normal variations that result from temperature changes, or from uncertainties in the charge and discharge current profiles.

A system that lacks this feedback would need to be conservative by using hard coded values for charge and discharge times, and charging and discharging current values, and these values would be chosen such that the worst case operating point could be satisfied. This “one setting fits all” approach would, on average, result in reducing the number of flash events that can be delivered in a given period.

A representative value for the capacitor 110 is 470 microfarads. A peak current for the LED is about 0.6 amperes (1 millisecond flash) and in the sustaining LED output mode this value drops to about 0.1 amperes.

While the present invention has been described with a degree of particularity, it is the intent that the invention includes all modifications and alterations from the disclosed design falling with the spirit or scope of the appended claims.

1. A barcode reader for imaging a target comprising:
an imaging system that includes a light monitoring pixel array for converting light reflected from a target into electrical signals;
an optical system having one or more focusing lenses positioned with respect to the pixel array to transmit an image of a target object toward said pixel array;
an illumination system comprising one or more light emitting diodes for illuminating a the target within a field of view defined by the optical system;
a drive circuit coupled to the one or more light emitting diodes of the illumination system including at least one energy storage capacitor for providing an electrical pulse to the one or more light emitting diodes for illuminating the target;
and
a discharge control for selectively energizing the light emitting diodes by discharging the at least one capacitor of the drive circuit.

2. The bar code reader of claim 1 wherein the discharge control comprises an adjustable current control circuit for controlling a discharge current from the capacitor through the one or more light emitting diodes.

3. The bar code reader of claim 2 wherein the adjustable current control is coupled to the discharge control for adjustment of the discharge current in response to a signal from the controller.

4. The reader of claim 1 wherein the drive circuit comprises a DC to DC boost circuit having a control input coupled to the discharge control, a voltage input for providing energy to the capacitor and an output for providing a boosted voltage for charging the capacitor.

5. The reader of claim 4 wherein the discharge control maintains a low level boost voltage across the light emitting diode subsequent to a controlled discharge of the capacitor at a high current to provide an initial flash of light output followed by a steady state light output.

6. The reader of claim 1 wherein the drive circuit is programmable to manage charge rate and peak current supplied to the one or more light emitting diodes.

7. The reader of claim 1 wherein the drive circuit implements a torch mode wherein the charge to the capacitor is controlled to maintain a minimum voltage across a current source.

8. The reader of claim 1 wherein several LEDs are coupled together in a series arrangement to increase efficient use of a capacitor discharge current.

9. A barcode reader for imaging a target comprising:
an imaging system that includes a light monitoring pixel array for converting light reflected from a target into electrical signals;
an optical system having one or more focusing lenses positioned with respect to the pixel array to transmit an image of a target object toward said pixel array;
an illumination system comprising one or more light emitting diodes for illuminating a the target within a field of view defined by the optical system;
a voltage boost circuit, coupled to the one or more light emitting diodes of the illumination system, providing energy to a storage element that supplies a current pulse to the one or more light emitting diodes for illuminating the target.

10. The barcode reader of claim 9 wherein the voltage boost circuit comprises a discharge control for selectively energizing the light emitting diodes by discharging at least one energy storage capacitor.

11. The barcode reader of claim 9 wherein the output voltage of the voltage boost circuit exceeds the input voltage of the voltage boost circuit before the current pulse is supplied to the one or more light emitting diodes.

12. A method for imaging a target with an imaging based bar code reader comprising:
positioning one or more focusing lenses with respect to a pixel array to transmit an image of a target object toward said pixel array;
providing one or more light emitting diodes for illuminating the target within a field of view defined by the focusing lenses;
storing energy in at least one energy storage capacitor for providing an electrical pulse that illuminates the target;
selectively energizing the light emitting diodes by discharging the at least one capacitor through at least one of said one or more light emitting diodes; and
converting light impinging on the pixel array reflected from a target into electrical signals for imaging.

13. The method of claim 12 wherein additionally coupling a programmable current source in series with the capacitor for regulating a discharge rate of the capacitor through the light emitting diode.

14. The method of claim 12 comprising adjusting a charge rate and peak current supplied to the storage capacitor.

15. The method of claim 12 wherein in a torch mode, charging of the storage capacitor is controlled to maintain a minimum voltage across a current source.

16. The method of claim 12 where several LEDs are coupled in series to simultaneously emit light as the capacitor is discharged.

17. The method of claim 12 wherein the voltage on the capacitor is sensed to determine when charging is completed and the capacitor can be discharged in flash mode.

18. The method of claim 12 wherein a voltage at a LED cathode is sensed to determine when discharge is completed and flash is done.

19. The method of claim 12 wherein voltage values are fed back to a controller which are evaluated in software to determine how much charge is available on the capacitor.

20. An imaging based barcode reader for imaging a target object comprising:
imaging means for forming an image on a light monitoring pixel array,
focusing means fixed with respect to the pixel array for focusing an image of a target object to the pixel array;
illumination means for illuminating a target object comprising:
charging means for storing a charge;
discharge means for providing a discharge path from the charging means and
light emitting means for responding to a discharge of the charging means by emitting a light pulse.

21. The reader of claim 20 additionally comprising a power supply means and wherein the charging means comprises a control means for managing charge rate and peak current supplied by the power supply means coupled to the charging means.

22. The reader of claim 20 comprising control means for maintaining a minimum fixed voltage across the discharge means.

23. The reader of claim 20 wherein the discharge means comprises a current source.

24. The reader of claim 20 wherein light emitting means comprises several LEDs stacked in a series arrangement.

25. The reader of claim 21 wherein the control means senses a voltage on the charging means to determine when charging has occurred to a sufficient level to produce a flash output from the light emitting means.

26. The reader of claim 21 wherein the control means senses voltage at the current source (LED's cathode) to determine when discharge is completed and flash is done.

27. The reader of claim 21 wherein the charging means comprises a capacitor and the control means includes software for determining if charging is needed, and for determining how much charge is available on the capacitor for producing an output from the charging means.

28. The reader of claim 21 wherein the control means is notified that the illumination means is ready to deliver a short burst of current to the light emitting means.

29. The reader of claim 27 wherein a notification to the control means is performed by monitoring when a threshold voltage on the capacitor is exceeded.

30. The reader of claim 27 wherein the illumination means comprises a light emitting diode and a notification to the control means occurs by monitoring voltage at a junction coupled to a light emitting diode that indicates a level of capacitor discharge.
